(19) United States
(12) Patent Application Publication
(10) Pub. No.: US 2009/0192856 A1
(43) Pub. Date: Jul. 30, 2009

(54) Business method for originating mortgages

(75) Inventor: Timothy L. Smith, Overland Park, KS (US)

Correspondence Address: ERICKSON, KERNELL, DERUSSEAU & KLEYPAS, LLC, 800 W. 47TH STREET, SUITE 401, KANSAS CITY, MO, 64112, US

(73) Assignee: REALTY FUNDING CORPORATION

(21) Appl. No.: 12/011,898

(22) Filed: Jan. 30, 2008

(51) Int. Cl. G06Q 10/00; G06Q 40/00; G06Q 50/00

(52) U.S. Cl. 705/8; 705/35; 705/38

(57) ABSTRACT

A method and model for originating mortgages is provided that includes a team of members for originating a mortgage having a first team member who supervises a second and third team member and provides home buying consulting services preferably as a licensed real estate agent and mortgage consulting services to a home buyer. The second team member is primarily responsible for the mortgage loan coordination. The third team member is primarily responsible for the mortgage loan processing. The first team member is compensated for providing the mortgage consulting services.

The invention relates to a mortgage origination model and more specifically, a mortgage origination model and method that enables realtors to provide a one-stop service to homebuyers by including mortgage services as part of their platform.

### BACKGROUND OF THE INVENTION

Traditionally, a home buyer has had to work independently with a realtor and then, a mortgage lender. This does not always provide the home buyer with quick and accurate loan decisions and competitive rates or closing costs.

Over the past several years, technological advances have opened new information sources for home buyers. For instance, the internet now helps buyers find the house they want, information on specific neighborhoods and areas, mortgage options and other home buying information. Studies have shown over 70 percent of homebuyers now turn to the internet to search for their next home. As home buyers become more knowledgeable, they expect access to broader product and mortgage selection, and better loan rates, closing costs and service in general.

Accordingly, real estate professionals should adapt to this changing environment. Real estate professionals have begun to embrace computer technologies and online marketing and business expansion products, such as instant messaging and online home searching. However, to be most successful, a realtor should provide exceptional customer service, unmatched product selection, local operations and competitive rates and closing costs all in a one-stop shop environment.

Real estate professionals have viewed the U.S. Department of Housing and Urban Development's (HUD) Real Estate Settlement Procedures Act (RESPA) as a (Docket 4090) roadblock to providing this bundle of services. RESPA is about closing costs and settlement procedures. RESPA requires that consumers receive disclosures at various times in the transaction and, among other things, prohibits realtor compensation that increases the cost of settlement services. RESPA is a HUD consumer protection statute designed to help homebuyers be better shoppers in the home buying process, and is enforced by HUD. RESPA is codified at 12 U.S.C. § 27 and is hereby incorporated herein by reference.

### BRIEF DESCRIPTION OF THE INVENTION

In an embodiment of the present invention a method for originating mortgages includes the steps of providing a team for originating a mortgage including a first team member who supervises a second and third team member and provides home buying consulting services preferably as a licensed real estate agent and mortgage consulting services to a home buyer. A second team member is provided primarily for mortgage loan coordination. A third team member is provided primarily for mortgage loan processing. Furthermore, training may be provided to the first team member to provide top quality mortgage consulting services. Finally, the method may include compensating the first team member for its mortgage consulting services.

Other advantages of this mortgage origination method and model will become apparent from the following description taken in connection with the accompanying drawing, and example an embodiment of the present invention.

### BRIEF DESCRIPTION OF THE DRAWINGS

FIG. 1 is a chart showing the three tier mortgage origination model of the present invention;

FIG. 2 is a diagram showing the role of the home buying specialist of the mortgage origination model of FIG. 1; and

FIG. 3 is a diagram showing the prior art, traditional mortgage origination model.

### DETAILED DESCRIPTION

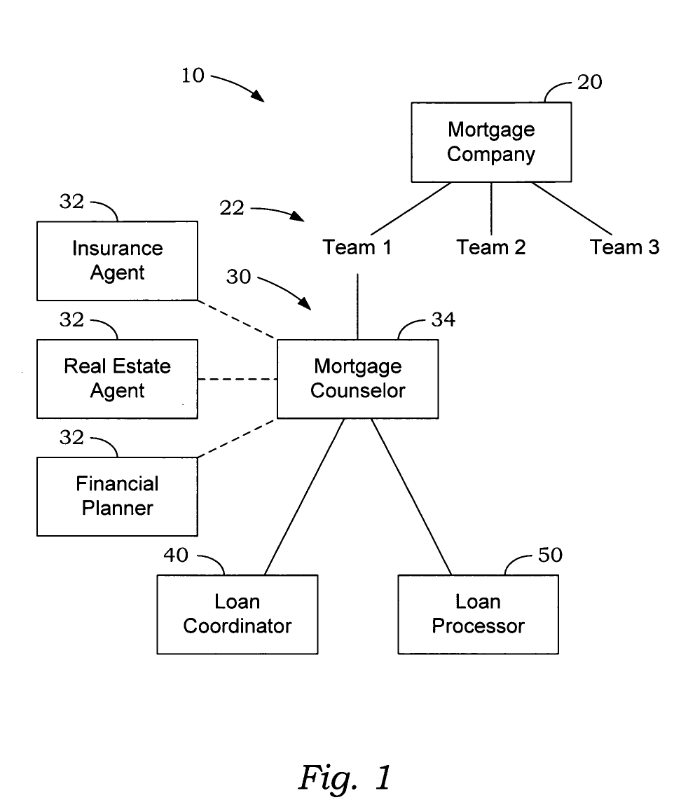

Referring to FIG. 1, a diagram of the method for originating home loans is illustrated and shows a generally three-tier home buying and mortgage origination model 10. A mortgage company 20 uses three tier teams 22, each of which include a home buying specialist 30, a loan coordinator 40 and a loan processor 50.

Although FIG. 1 shows a mortgage company 20 with three teams 22, it should be understood that the mortgage company 20 may have any number of teams 22. Furthermore, although the three tiers 30, 40 and 50 are only shown with respect to one team 22, it should be understood that each team 22 has these same tiers.

The first tier in the team 22 is the mortgage counselor 30. This counselor 30 is a licensed real estate agent, insurance agent or financial planner 32 as well as a trained mortgage team manager 34. The mortgage counselor 30 works closely with each home buyer/borrower 36 throughout the entire home buying and mortgage process. More specifically, as the real estate agent 32, the mortgage counselor 30 assists a home buyer in finding the desired home to buy. Thereafter, as the team manager 34, the mortgage counselor 30 maintains delegation and supervisory control over the mortgage team 22. Thus, the mortgage counselor 30 oversees and controls the entire home purchasing process, from the home shopping phase to the loan application phase and finally to closing.

Because the mortgage counselor 30 maintains her qualification as a real estate agent, insurance agent or financial planner of another firm, her employment relationship with the mortgage company 20 is preferably as an independent contractor. This independent contractor status may provide other benefits, i.e., tax, as well.

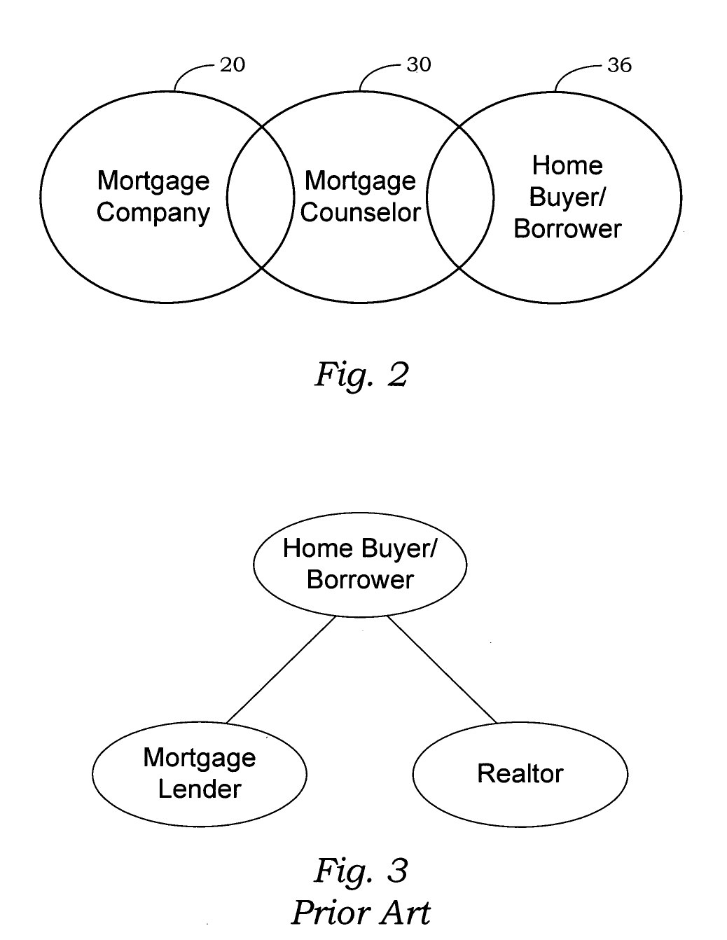

As further detailed herein and shown in FIG. 2, this team model highlights the value of the mortgage counselor 30 to the home buyer 36 while also creating the optimum home buying experience for the home buyer 36. It allows the home buyer 36 to quickly and easily locate mortgage lending information and options while staying connected to one source who can offer not only home buying counseling but mortgage counseling as well. This is in contrast to the traditional model, as shown in FIG. 3.

As the mortgage counselor 30, the mortgage counselor 30 originates loans. To do so, the mortgage counselor 30 must be in compliance with RESPA regulations. To be compliant, the mortgage counselor 30 must meet certain state licensing and continuing education requirements, be willing to offer certain disclosures and offer the home buyer three choices for mortgage services. Preferably, the mortgage counselor 30 will provide the mortgage company 20 and two additional mortgage lenders referrals to the potential home buyer 36.

More specifically, the following eight services are preferably performed by the mortgage counselor 30:
1. Gathering information from the home buyer/borrower and filling out the loan application.
2. Analyzing the prospective borrower's income and debt and pre-qualifying the prospective home buyer to determine the maximum mortgage that the prospective home buyer can afford;
3. Educating the prospective home buyer in the home buying and financing process, advising the home buyer about the different types of basic loan products available, and explaining how closing costs and monthly payments could vary under each product;
4. Collecting financial information (e.g., tax returns, bank statements) and other related documents that are part of the application process;
5. Initiating and/or ordering inspections, such as the house inspection, radon inspection, etc. or engineering reports;
6. Assisting the potential home owner in understanding and reading the credit report;
7. Maintaining regular contact with the home buyer/borrower and the lender, from application to the closing, to apprise the home buyer of the loan status and gather any additional information as needed; and
8. Participating in the loan closing, including reviewing the HUD, communicating with the home buyer the closing date and time and attending the closing if possible.

HUD, through Section 8 of RESPA, prohibits payment from mortgage lenders/brokers to realtors unless a certain number of compensable services are performed by the realtor. In a letter to the Independent Bankers Association of America dated Feb. 14, 1995 (IBAA letter) hereby incorporated herein by reference, HUD identified further services normally performed in the organization of a loan including the eight services identified above. HUD concluded that five of the fourteen identified services must be performed to meet RESPA guidelines for payment. Accordingly, by this method, the mortgage counselor 30 not only meets but exceeds the RESPA regulations and may be compensated, and the mortgage counselor 30 can earn a commission in addition to the real estate agency fees.

Preferably, the mortgage company 20 trains the real estate agent 32 to become qualified as a mortgage counselor 34. The training may be in person or online. Additionally, the mortgage company 20 preferably offers access to a web-based software that assists the home buying specialization with her mortgage counseling duties. One such software is sold under the brand name Encompass® by Ellie Mae® of Dublin, Calif. Such software enables a mortgage counselor 34 to obtain timely approvals from Fannie Mae® and Freddie Mac®. Such software also allows the mortgage counselor 34 to track each home buyer's loan twenty-four hours a day, seven days a week. Finally, this type of software assists the mortgage counselor 34 with services 1-2, 6 and 7 above.

The second tier of each team 22 includes two members, the loan coordinator 40 and the loan processor 50. The loan coordinator 40 is the team's mortgage expert and is responsible for finding the best mortgage loan, rate and closing costs for each home buyer's needs. The loan coordinator 40 may meet with the home buyer 36, lock the loan, produce Good Faith Estimates, truth-in-lending documents, run pre-approvals as needed, etc.

Once the loan is locked, the loan is passed to the other member of the team's second tier: the loan processor 50. The loan processor 50 validates information, orders documents and prepares for closing.

This two-tier team model 10 allows the mortgage company 20 to offer very competitive rates as a result of the high loan production (as opposed to high profit per loan). Furthermore, the mortgage counselor 30 can be rewarded every time one of her home buyers returns to the mortgage company 20 to refinance, relocate, take out a second or investment loan or refers another potential home buyer/borrower, the mortgage counselor 30 requires a commission in that loan also. The mortgage company's staff, i.e., the loan coordinators 40 and the loan processors 50, is preferably on a fixed compensation plan, with no overages permitted. This is in contrast to the more traditional practice of paying loan officers based on net profitability so the higher the interest rate and the higher the closing costs the home buyer accepts, the more the loan officer is compensated.

Having thus described the invention what is claimed as new and desired to be secured by Letters Patent is as follows:

1. A method for originating mortgages, comprising the steps of:
providing a team for originating a mortgage, including a first team member who supervises a second and third team member;
providing home buying consulting services and mortgage consulting services to a home buyer through said first team member.

2. The method as claimed in claim 1, further comprising the step of:
providing a second team member primarily responsible for mortgage loan coordination.

3. The method as claimed in claim 2, further comprising the step of:
providing a third team member primarily responsible for mortgage loan processing.

4. The method as claimed in claim 1, further comprising the step of:
training the first team member how to provide the mortgage consulting services.

5. The method as claimed in claim 1, further comprising the step of:
compensating the first team member for the mortgage consulting services.

6. A method for originating mortgages, comprising the steps of:
providing a first member, who is a licensed real estate agent trained to provide mortgage consulting services;
providing a second member who originates mortgage loans; and
providing a third member who processes mortgage loans.

7. The method as claimed in claim 6, further comprising the step of:
training the first member how to provide the mortgage consulting services.

8. The method as claimed in claim 6, further comprising the step of:
providing coordination and supervision over the second and third members by the first member.

9. The method as claimed in claim 6 wherein the mortgage counseling services include performing at least five services from the group consisting of:
gathering information from the home buyer for the loan application;
pre-qualifying the home buyer for a mortgage;
educating the prospective home buyer in the financing process;
collecting financial information for the loan application;
initiating home inspections;
assisting the home buyer in understanding the credit report;
maintaining regular contact with the home buyer and the lender from application to closing; and
participating in the loan closing.

10. A mortgage origination business model, comprising:
a mortgage origination team having a first member, a second member and a third member, said first member providing both home buying consulting services and mortgage loan consulting services to a home buyer and for supervising said second and third team members.

11. The mortgage origination model as claimed in claim 10, wherein said second member is a mortgage loan coordinator.

12. The mortgage origination model as claimed in claim 10, wherein said third member is a mortgage loan processor.
